(19) United States
(12) Patent Application Publication
(10) Pub. No.: US 2015/0305548 A1
(43) Pub. Date: Oct. 29, 2015

(54) FOOD OR BEVERAGE PRODUCTION SYSTEM

(71) Applicant: NESTEC S.A., Vevey (CH)

(72) Inventors: Olivier Girault, Vevey (CH); Alexis Reust, Lausanne (CH)

(21) Appl. No.: 14/654,610

(22) PCT Filed: Dec. 18, 2013
(86) PCT No.: PCT/EP13/77112

§ 371 Date: Jun. 22, 2015

(30) Foreign Application Priority Data
Dec. 21, 2012 (EP) 12198942.0

(51) Int. Cl. A47J 31/44; A47G 19/22

(52) U.S. Cl. CPC A47J 31/4492; A47G 19/2227

(57) ABSTRACT

The invention concerns a system for preparing a beverage comprising: a drinking cup (1) carrying an identifier (11), said identifier encoding information related to the shape of the drinking cup, and a beverage dispenser configured for preparing a beverage by introducing a beverage concentrate ingredient (10) in the drinking cup (1) and introducing a diluent in the drinking cup for mixing the liquid and the beverage concentrate ingredient inside the drinking cup, said dispenser comprising: diluent supply means (8), support means (6) for supporting the drinking cup, at least one nozzle (32) for introducing the diluent in the drinking cup, means (322, 62) for adapting the relative distance (d2) between the support means of the drinking cup and the at least one nozzle, and a sensing device (2) adapted to obtain information about the shape of said drinking cup.

### FIELD OF THE INVENTION

The present invention relates to beverage dispensers configured for providing hot and cold beverages by mixing a soluble beverage ingredient and a diluent in a drinking cup.

### BACKGROUND OF THE INVENTION

It is known to prepare beverages by mixing a beverage concentrate such as a dry powder or a liquid concentrate with a diluent such as cold or hot water. One way to implement the mixing of the concentrate and the diluent is the so-called in-cup mixing where a dose of the beverage concentrate is introduced into a drinking cup and then at least a stream or jet of diluent is introduced to the cup in order to enable an interaction of the beverage concentrate and the diluent. Accordingly, the beverage concentrate is dissolved and eventually frothed by the diluent in order to prepare the beverage. Usually the dose of concentrate that is introduced in the empty drinking cup is dosed and dispensed from a storage tank.

The dispenser can comprise several storage tanks holding different types of concentrates—e.g. coffee powder, milk powder, cocoa powder, tea powder—for preparing different types of beverages from each powder or by mixtures of said powders. The dispenser is configured for introducing the jet of diluent in the cup according to specific parameters depending on the nature of the ingredient to be dissolved. These parameters can relate to the volume of diluent introduced in the cup, the velocity of the diluent jet, the movement of the diluent jet during dispensing and influence the effective dissolution of the concentrate and also the texture of the concentrate. For example a high jet velocity enables the incorporation of air in the beverage during its preparation and the creation of foam on the top of the beverage; such a foam is desired for a milky or chocolate beverage but not for a tea. In that last case the diluent shall be introduced with a low velocity in order to create fewer bubbles as possible on the surface of the final beverage. Usually the controller of the dispenser stores information about the process of dissolution in relation to each concentrate and each selected beverage.

Improved beverage dispensers have been developed to get optimised in-cup mixing. In particular dispensers have been defined with:
particular number of diluent jets,
particular orientation or positioning of the diluent jets in the cup,
supply of diluent jets with particular velocities,
movements of the cup or the jets during the supply of diluent.

Usually each beverage dispenser is built to define a specific optimised in-cup mixing corresponding to a particular cup presenting a particular shape (size, bottom surface, walls angle of its walls, . . . ) so that the diluent jets hit the cup walls on always the same cup locations as illustrated for example in WO2010034722. If the dispenser is used with another type of cup, then the jet(s) of the device may not correctly mix the food ingredient at the bottom of the cup and the device should be redesigned. Then the problem of beverage dispensers implementing in-cup mixing is that their efficiency is totally dependent from the cups that are used with the dispenser. If the consumer uses a cup that is not designed for fitting with the diluent jets orientation then the mixing is not efficient and the consumer is disappointed. The problem may occur when there is rupture in the supply of cups usually associated with the beverage dispenser and replacement cups are used.

The object of the present invention is to propose a solution to the above problems related to the use of different types of cups with an in-cup mixing beverage dispenser.

### SUMMARY OF THE INVENTION

According to a first aspect, the invention concerns a drinking cup carrying an identifier, said identifier encoding information related to the shape of the drinking cup, wherein the shape consists in the size (S) of the area of the cup bottom, the height (h) of the cup and the angle (β) of lateral walls with vertical.

According to the invention the cup carries an identifier. Preferably the identifier is chosen in the group of an RFID tag, a bar code, an optical code. The identifier is generally positioned on the external surface of the drinking cup preferably under the bottom wall.

The drinking cup is usually a single use cup. It is usually disposable. It is generally a cup made out of cardboard material or similar. Preferably the drinking cup presents a frustoconical shape.

According to a second aspect, the invention concerns a beverage dispenser configured for preparing a beverage by introducing a beverage concentrate ingredient in a drinking cup and introducing a diluent in the drinking cup for mixing the diluent and the beverage concentrate ingredient inside the drinking cup, said dispenser comprising:
diluent supply means,
support means for supporting the drinking cup,
at least one nozzle for introducing the liquid in the drinking cup,
means for adapting the relative distance between the support means of the drinking cup and the at least one nozzle,
a sensing device adapted to obtain information about said drinking cup by receiving or reading information from the cup and/or by measuring at least one of the following characteristic of the cup: spectral property, colour, electrical property, resistivity, capacitance, electromagnetic property, magnetic induced field, mechanical property, geometry, weight, identifier, code bar, emitted or reflected signal,
   said sensing device being interconnected with the controller of the dispenser so that in function of the information obtained about the drinking cup the controller adapts the distance between the support and the at least one nozzle.

According to one mode the means for adapting the relative distance between the support means of the drinking cup and the at least one nozzle comprises means for vertically moving the support means of the drinking cup.

According to another mode the means for adapting the relative distance between the support means of the drinking cup and the at least one nozzle comprises means for vertically moving the at least one nozzle.

The two above modes can be combined although it is usually preferable to displace the support of the drinking cup rather than the nozzle(s).

According to the preferred embodiment the dispenser comprises at least one nozzle configured for directing a jet of liquid on the bottom surface of the cup and at least one nozzle configured for directing a jet of liquid on the sidewall of the cup. According to a preferred embodiment the dispenser presents the feature of the dispenser described in WO 2010/034722.

Preferably the dispenser comprises means for storing at least one beverage concentrate ingredient and means for dosing said beverage concentrate ingredient and delivering it in the drinking cup.

According to a third aspect, the invention concerns a beverage production system of a drinking cup according to the first aspect and a beverage dispenser according to the second aspect.

According to one preferred embodiment the sensing device is a reading device for reading encoded information carried by the drinking cup, said reading device being interconnected with the controller of the dispenser so that the controller adapts the distance between the support and the nozzle based on the encoded information read on the drinking cup.

According to a fourth aspect, the invention concerns the use of a container according to the first aspect with a beverage dispenser according to the second aspect.

According to a fifth aspect, the invention concerns method for dispensing a beverage with a system such as described hereabove, which method comprises:
a) placing the drinking cup carrying the identifier in or close to the sensing device of the beverage dispenser,
b) reading the encoded information carried by the drinking cup,
c) preparing the beverage according to information obtained about the drinking cup.

Usually step c) comprises the sub-step of adapting the relative distance between the support and the nozzle based on the encoded information read on the drinking cup. This sub-step is implemented before the diluent is introduced in the drinking cup through the at least one nozzle.

Preferably in the preparation of the beverage in step c) a dose of beverage concentrate ingredient is introduced in the drinking cup and subsequently the diluent is introduced in the drinking cup for mixing the liquid and the beverage concentrate ingredient inside the drinking cup.

In the dispenser and system of the present invention the diluent is preferably water.

In the dispenser and system of the present invention the beverage concentrate ingredient can be a powder or a liquid concentrate. Preferably the beverage concentrate ingredient is selected in the list of instant coffee powder, milk powder, instant tea powder, cocoa powder, soup powder or mixture of said powders. The beverage concentrate can also be a liquid selected in the list of a coffee concentrate, a milk concentrate, a syrup.

### BRIEF DESCRIPTION OF THE DRAWINGS

The characteristics and advantages of the invention will be better understood in relation to the following figures:

FIG. 1 illustrates a dispenser according to the present invention according to a first embodiment.

FIG. 2 illustrates a dispenser according to the present invention according to a second embodiment.

FIG. 3 illustrates an assembly of sub-nozzles that can be implemented in a dispenser according to FIG. 1.

FIG. 4 illustrates the general features of a cup with frustoconical shape.

### DETAILED DESCRIPTION OF THE DRAWINGS

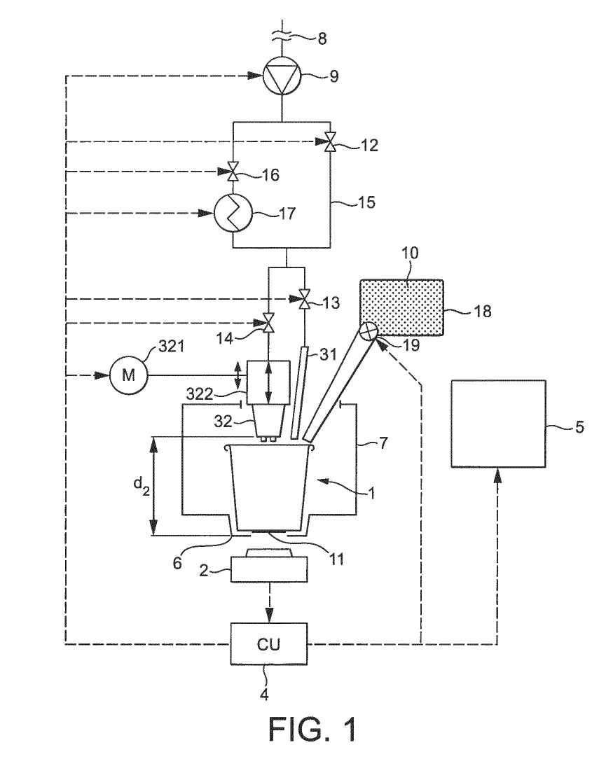

FIG. 1 illustrates a beverage dispenser according to an embodiment of the present invention configured for preparing a beverage inside a drinking cup 1. The dispenser comprises a dispensing area 7 and support means 6 configured for receiving the drinking cup 1. The dispenser comprises a tank 18 for storing a beverage ingredient 10 and a dosing device 19 for metering a dose of concentrate from the tank and delivering it in the drinking cup.

The dispenser comprises several nozzles for introducing a diluent in the drinking cup 1 in order to dissolve the dose of beverage concentrate delivered in the cup. FIG. 1 illustrates a dispenser with two different types of nozzles 31 and 32. A first nozzle 31 enables the introduction of a free flow of diluent that is at low pressure. This kind of nozzle enables the rapid and gently filling of the drinking cup; it is useful for producing beverage for which no bubble or foam is desired on the top surface like tea or for completing the filling of a beverage which has been previously foamed. Such a nozzle 31 can present an outlet diameter comprised between 4 and 15 mm, preferably between 8 and 10 mm. The second nozzle 32 is an assembly of several sub-nozzles enabling the introduction of several jets of diluent at high pressure in the cup.

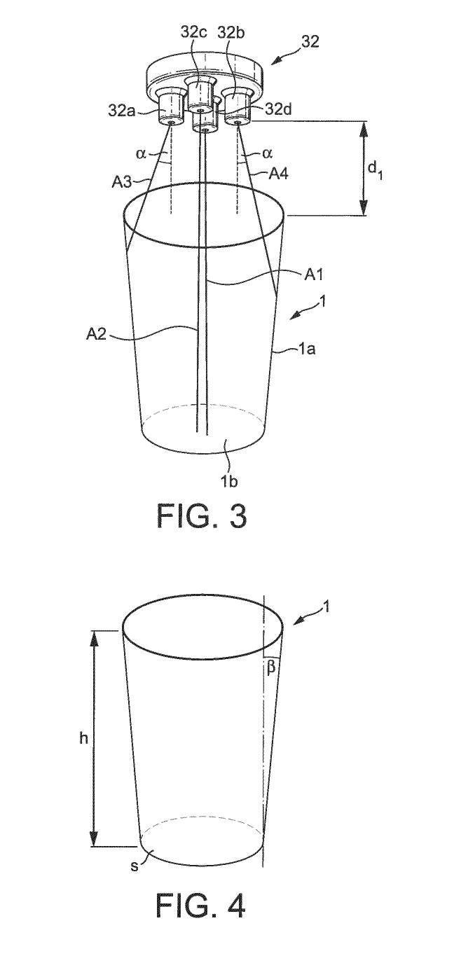

FIG. 3 illustrates such an assembly of sub-nozzles and the way these nozzles introduce the diluent in a cup. The assembly comprises four sub-nozzles 32a, 32b, 32c and 32d. Each nozzle is oriented so that it produces a jet of diluent according to a specific orientation and so that the diluent hits the drinking cup at a specific place. For example as illustrated in FIG. 6, two of the sub-nozzles 32a, 32b direct a diluent jet A3, A4 to an inner side wall 1a of the cup and are arranged at different angles (a) with respect to the vertical, and at least two of the sub-nozzles 32c, 32d are designed to direct a diluent jet A1, A2 to the bottom of the cup 1b and are arranged at different angles (β) with respect to the vertical. FIG. 3 illustrates the importance of using always the same shape of cup when a nozzle configuration is set. The jets of diluent are defined to provide specific mixing to get the full dissolution for the beverage ingredient placed in the cup and to provide specific agitation to introduce air in the beverage and get the requested foam. If the shape of the cup (surface of the bottom S, angles of the lateral walls β, height h such as illustrated in FIG. 4) changes then the diluent jets do not produce the optimal dissolution and agitation, and finally the quality of the beverage can be disappointing.

Preferably nozzles 32 providing jets of diluent at high pressure present an outlet diameter comprised between 0.5 and 2.5 mm preferably between 0.6 and 1.5 mm. In the embodiment of FIG. 1 the second nozzle 32 can be moved in particularly rotated during the dispensing of diluent in the cup. The movement is produced by a motor 321 to which the second nozzle 32 is connected.

The motor 321 can also be used to change the relative distance between the drinking cup placed in the dispensing area and the nozzle 32.

The nozzles 31, 32 are supplied with the diluent that is usually water. The supply of water comprises a source 8 which can be a tank or tap water. A pump 9 drives the water from the source 8. The dispenser comprises a heater 16 to heat the water for the preparation of hot beverages. Alternatively for the production of beverages at ambient temperature the dispenser comprises a by-pass line 15 from the pump outlet to the nozzles. Valves 16, 12 enable the selection of the temperature of the beverage. Two others valves 13, 14 respectively enable the supply of the first nozzle 31 or the second nozzle 32. The dispenser comprises means 322 for vertically moving the second nozzle 32 and adapting the relative distance d2 between said nozzle and the support means 6 of the drinking cup. Consequently the second nozzle 32 can be vertically positioned to optimally introduce the jets of diluent in the drinking cup.

The dispenser comprises a sensing device 2 adapted to obtain information about the shape of the drinking cup 1. According to one mode the information can be obtained by receiving or reading information from the cup, in particular by reading information encoded by an identifier 11 that the cup carries. This identifier 11 can be an RFID tag, a bar code, an optical code. The information encoded by the identifier relate at least to the shape of the cup and preferably for a frustoconical shape to at least one of the following information:
the size S of the area of the cup bottom,
the height h of the cup,
the angle β of lateral walls with vertical,
   such as illustrated in FIG. 4.

According to another mode the information can be obtained by measuring at least one of the following characteristic of the cup: spectral property, colour, electrical property, resistivity, capacitance, electromagnetic property, magnetic induced field, mechanical property, geometry, weight, emitted or reflected signal. This measurable characteristic can be further selected to provide or refer to information related to the detected cup to the control unit (or controller) 4 through the sensing device 2. Some characteristics may be obtained passively by a sensor without interacting with the cup. For instance, it is possible to recognize an outside color of a part of the cup. Other characteristics may be obtained actively by a sensor in interacting with the cup. For example the sensor may apply an alternative current to the detected cup and then may measure parameters of the inductive field generated this way and/or resistivity and/or capacitance of the detected cup.

In the configuration of the dispenser illustrated in FIG. 1 the sensing device is adapted for reading an identifier 11 placed on the bottom of the drinking cup 1. It is consequently placed under the cup support and for this reason it is preferable that said cup support is not made movable.

The reading device 2 is connected to the controller 4 of the dispenser so that in function of the information obtained by the sensing device 2 the controller 4 adapts the relative distance d2 between the support 6 and the at least one nozzle 31 in particular by activating the motor 321 of the means 322 for vertically moving the second nozzle 32. For example if the cup presents a height h smaller than a standard cup then the controller 4 makes the motor 321 move the second nozzle 32 downwards so that the jets A3, A4 such as illustrated in FIG. 3 correctly hits the lateral walls of the cup and not out of the cup. The controller 4 can also control other aspects of the beverage preparation based on the information obtained by the sensing device about the cup. In particular the volume of beverage prepared in the cup based on the size of the cup can be controlled and consequently the controller 4 can control:
the activation of the water pump 9 to control the volume of dispensed water,
the activation of the dosing device 19 to control the volume of dispensed beverage concentrate.

The activation relates at least to the following aspects:
switching on or off the corresponding device,
the time at which the corresponding device is activated,
the time during which the corresponding device is activated,
the speed of the motors of the pump, and of the device for rotating nozzles.

The information obtained from the identifier 11 on the drinking cup 1 provides the controller with information for implementing the optimal water introduction in the cup to get the optimal beverage from the beverage concentrate ingredient present in the cup and based on the shape of the cup.

The dispenser forms a system with the drinking cup 1 carrying the identifier 11 on its bottom side with the identifier encoding information about the shape of the cup.

The dispenser can also comprise a user interface 5 like a screen on which information related to the beverage under preparation can be presented to the consumer; these information can again be obtained from the information sensed by the sensing device 2 through the conductive or dielectric pattern 11.

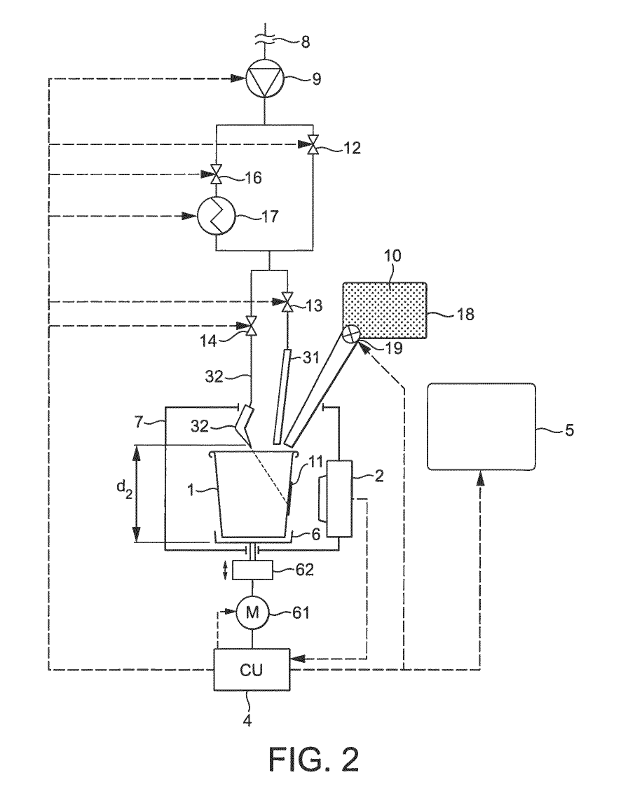

FIG. 2 illustrates a beverage dispenser according to another embodiment of the present invention wherein another particular embodiment of the nozzles is implemented, another type of device for adapting the distance between the cup and the nozzles is used and another position of the sensing device is implemented.

The beverage dispenser of FIG. 2 is configured for preparing a beverage with a drinking cup that carries an identifier on its external lateral side wall.

In the dispenser of FIG. 2 the second nozzle 32 of the dispenser is a single tube presenting a shape configured for producing a water jet at high pressure, preferably a tube having a diameter outlet comprised between 0.5 and 2.5 mm preferably between 0.6 and 1.5 mm, even preferably a nozzle having an internal bore tapering to said outlet diameter. This nozzle is oriented so that the water jet emerging therefrom hits the lateral internal side of the drinking cup at a particular height. This feature can be important to get en optimised dissolution of the concentrate in the cup without having lump of beverage concentrate floating at the surface of the prepared beverage.

The dispensing area 7 comprises a cup support 6 which can be made moved by a device 62 actuated by a motor 61. The movement is a vertical movement to adapt the distance between the cup 1 and the nozzles 31, 32. The movement can also be combined with a rotation of the cup on itself to improve the preparation of the beverage.

The dispenser is configured for forming a system with a drinking cup 1 carrying an identifier 11 on its lateral external side. The reading device 2 of the dispenser is positioned so as to be able to read information on said side of the cup when the cup is placed in the dispenser on the cup support. The reading device can present the same features as in the dispenser of FIG. 1 except that it is adapted for reading an identifier 11 placed on the lateral side of the drinking cup 1. The reading device 2 is connected to the controller 4 of the dispenser so that in function of the information obtained by the sensing device 2 the controller 4 adapts the relative distance d2 between the support 6 and the at least one nozzle 31 in particular by activating the motor 61 of the device 62 for vertically moving the drinking cup 1. For example if the cup presents a height h smaller than a standard cup then the controller 4 makes the motor 61 move the second nozzle 62 upwards so that the jets from the nozzle 32 correctly hits the lateral walls of the cup and not out of the cup. The controller 4 can also control other aspects of the beverage preparation based on the information obtained by the sensing device about the cup. In particular the volume of beverage prepared in the cup based on the size of the cup can be controlled and consequently the controller 4 can control:
the activation of the water pump 9 to control the volume of dispensed water,
the activation of the dosing device 19 to control the volume of dispensed beverage concentrate.

The activation relates at least to the following aspects:
switching on or off the corresponding device,
the time at which the corresponding device is activated,
the time during which the corresponding device is activated,
the speed of the motors of the pump and of the device for rotating the cup.

Depending on the activation or not of these different devices according to specific time sequences, different type of dilution processes can be implemented by the dispenser. The identifier 11 on the drinking cup provides the dispenser with information for implementing the optimal water introduction in the cup to get the optimal beverage from the beverage concentrate ingredient present in the cup and based on the shape of the cup.

The dispenser also comprises a user interface 5 like a screen on which information related to the beverage under preparation can be presented to the consumer; these information can again be obtained from the information sensed by the reading device 2 through the conductive or dielectric pattern 11.

The dispensers of FIGS. 1 and 2 are particularly detailed to explain the operations of the means for introducing the diluent in the drinking cup, of the reading device and of the dispenser controller. But the present invention is not limited to these both particular embodiments of FIGS. 1 and 2. Any combination of nozzles configuration could be used with any position of the reading device in the dispensing area and any type of reading device.

The present invention presents the advantage of having the possibility to use any shape of drinking cup with an in-cup mixing dispenser and maintaining the optimal conditions of mixing whatever the shape of the cup.

1. A drinking cup carrying an identifier, the identifier encoding information related to the shape of the drinking cup, wherein the shape consists in the size of the area of the cup bottom, the height of the cup and the angle (β) of lateral walls with vertical.

2. A drinking cup cording to claim 1 wherein the identifier is selected from the group consisting of an RFID tag, a bar code, and an optical code.

3. A drinking cup according to claim 1, wherein the drinking cup is a single use cup.

4. A drinking cup according to claim 1, wherein the drinking cup presents an essentially frustoconical shape.

5. A beverage dispenser configured for preparing a beverage by introducing a beverage concentrate ingredient in a drinking cup and introducing a diluent in the drinking cup for mixing the liquid and the beverage concentrate ingredient inside the drinking cup, the dispenser comprising:
a diluent supply;
a support for supporting the drinking cup;
at least one nozzle for introducing the diluent in the drinking cup;
a member for adapting the relative distance between the support of the drinking cup and the at least one nozzle;
a sensing device adapted to obtain information about the drinking cup by receiving or reading information from the cup and/or by measuring at least a characteristic of the cup selected from the group consisting of: spectral property, color, electrical property, resistivity, capacitance, electromagnetic property, magnetic induced field, mechanical property, geometry, weight, identifier, code bar, emitted and reflected signal: and
the sensing device being interconnected with the controller of the dispenser so that in function of the information obtained related to the shape of the drinking cup the controller adapts the relative distance between the support and the at least one nozzle.

6. A beverage dispenser according to claim 5 wherein the member for adapting the relative distance between the support of the drinking cup and the at least one nozzle comprises a member for vertically moving the support of the drinking cup.

7. A beverage dispenser according to claim 1 comprising a member for adapting the relative distance between the support of the drinking cup and the at least one nozzle comprises a member for vertically moving the at least one nozzle.

8. A beverage dispenser according to claim 5 comprising at least one nozzle configured for directing a jet of liquid on the bottom surface of the cup and at least one nozzle configured for directing a jet of liquid on the sidewall of the cup.

9. A beverage dispenser according to claim 5 wherein the dispenser comprises a storage for storing at least one beverage concentrate ingredient and a dosing member for the beverage concentrate ingredient and delivering it in the drinking cup.

10. (canceled)

11. A system comprising:
a beverage dispenser configured for preparing a beverage by introducing a beverage concentrate ingredient in a drinking cup and introducing a diluent in the drinking cup for mixing the liquid and the beverage concentrate ingredient inside the drinking cup, comprising:
a diluent supply;
a support for supporting the drinking cup;
at least one nozzle for introducing the diluent in the drinking cup;
a member for adapting the relative distance between the support of the drinking cup and the at least one nozzle;
a sensing device adapted to obtain information about the drinking cup by receiving or reading information from the cup and/or by measuring at least a characteristic of the cup selected from the group consisting of: spectral property, color, electrical property, resistivity, capacitance, electromagnetic property, magnetic induced field, mechanical property, geometry, weight, identifier, code bar, emitted and reflected signal;
the sensing device being interconnected with the controller of the dispenser so that in function of the information obtained related to the shape of the drinking cup the controller adapts the relative distance between the support and the at least one nozzle; and
the sensing device is a reading device configured for reading the encoded information carried by the drinking cup, the reading device being interconnected with the controller of the dispenser so that the controller adapts the relative position of the support to the nozzle based on the encoded information read on the drinking cup.

12. (canceled)

13. A method for dispensing a beverage with a system comprising a beverage dispenser configured for preparing a beverage by introducing a beverage concentrate ingredient in a drinking cup and introducing a diluent in the drinking cup for mixing the liquid and the beverage concentrate ingredient inside the drinking cup, the dispenser comprising a diluent supply, a support for supporting the drinking cup, at least one nozzle for introducing the diluent in the drinking cup, a member for adapting the relative distance between the support of the drinking cup and the at least one nozzle, a sensing device adapted to obtain information about the drinking cup by receiving or reading information from the cup and/or by measuring at least a characteristic of the cup selected from the group consisting of: spectral property, color, electrical property, resistivity, capacitance, electromagnetic property, magnetic induced field, mechanical property, geometry, weight, identifier, code bar, emitted and reflected signal, and the sensing device being interconnected with the controller of the dispenser so that in function of the information obtained related to the shape of the drinking cup the controller adapts the relative distance between the support and the at least one nozzle and the sensing device is a reading device configured for reading the encoded information carried by the drinking cup, the reading device being interconnected with the controller of the dispenser so that the controller adapts the relative position of the support to the nozzle based on the encoded information read on the drinking cup, the method comprises:
placing the drinking cup carrying the identifier in or close to the sensing device of the beverage dispenser;
reading the encoded information carried by the drinking cup; and
preparing the beverage according to information obtained about the drinking cup.

14. The method according to claim 13, comprising adapting the relative distance between the support and the nozzle based on the encoded information read on the drinking cup.
